(19) United States
(12) Patent Application Publication
(10) Pub. No.: US 2009/0227801 A1
(43) Pub. Date: Sep. 10, 2009

(54) LIGANDS FOR USE IN ASYMMETRIC HYDROFORMYLATION

(75) Inventors: Wolfgang Ahlers, Worms (DE); Martina Egen, Dossenheim (DE); Martin Volland, Heidelberg (DE); Christoph Jakel, Limburgerhof (DE); Frank Hettche, Weinheim (DE); Rocco Paciello, Bad Durkheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF AKTIENGESELLSCHAFT, Ludwigshafen (DE)

(21) Appl. No.: 11/577,952

(22) PCT Filed: Oct. 10, 2005
(86) PCT No.: PCT/EP05/11449

§ 371 Date: Apr. 25, 2007

(30) Foreign Application Priority Data
Oct. 26, 2004 (DE) 10 2004 052 040.2

(51) Int. Cl. C07F 9/572; C07F 15/00

(52) U.S. Cl. 548/101; 548/412

(57) ABSTRACT

The invention relates to chiral phosphorus chelate compounds, to catalysts comprising such a compound such a compound as the ligand, and to asymmetric synthesis methods in the presence of such a catalyst.

The present invention relates to chiral chelating phosphorus compounds, catalysts comprising such a compound as ligand and a process for asymmetric synthesis in the presence of such a catalyst.

Asymmetric synthesis is the name given to reactions in which a chiral group is generated from a prochiral group, so that the stereoisomeric products (enantiomers or diastereomers) are formed in unequal amounts. Asymmetric synthesis has gained immense importance, especially in the pharmaceutical industry, since it is frequently the case that only one particular optically active isomer is therapeutically active. There is therefore a continual need for new asymmetric synthesis processes and especially catalysts having a high asymmetric induction for particular stereocenters, i.e. the synthesis should lead to the desired isomers in high optical purity and in high chemical yield.

An important class of reactions is addition onto carbon-carbon and carbon-heteroatom multiple bonds. The addition onto the two adjacent atoms of a C═X double bond (X═C, heteroatom) is also referred to as 1,2-addition. Addition reactions can also be classified according to the type of groups added on, so that hydroaddition is the addition of a hydrogen atom and carboaddition is the addition of a carbon-comprising fragment. Thus, a 1-hydro-2-carbo-addition is an addition of hydrogen and a carbon-comprising group. Important representatives of this reaction are, for example, hydroformylation, hydrocyanation and carbonylation. A further very important addition onto carbon-carbon and carbon-heteroatom multiple bonds is hydrogenation. There is a need for catalysts for asymmetric addition reactions on prochiral ethylenically unsaturated compounds which display good catalytic activity and high stereoselectivity.

Hydroformylation or the oxo process is an important industrial process and is employed for preparing aldehydes from olefins, carbon monoxide and hydrogen. These aldehydes can, if appropriate, be hydrogenated by means of hydrogen to form the corresponding oxo alcohols in the same process. Asymmetric hydroformylation is an important method of synthesizing chiral aldehydes and is of interest as a route to chiral building blocks for the preparation of aromas, cosmetics, crop protection agents and pharmaceuticals. The hydroformylation reaction itself is strongly exothermic and generally proceeds under superatmospheric pressure and at elevated temperatures in the presence of catalysts. Catalysts used are Co, Rh, Ir, Ru, Pd or Pt compounds or complexes which may be modified by means of N-, P-, As- or Sb-comprising ligands to influence the activity and/or selectivity. In the hydroformylation reaction of olefins having more than two carbon atoms, mixtures of isomeric aldehydes can be formed as a result of the possible addition of CO onto each of the two carbon atoms of a double bond. In addition, when olefins having at least four carbon atoms are used, double bond isomerization can result in the formation of mixtures of isomeric olefins and possibly also isomeric aldehydes. The use of chiral catalysts can result in the formation of mixtures of enantiomeric aldehydes. For these reasons, the following conditions have to be met in order to achieve efficient asymmetric hydroformylation: 1. high activity of the catalyst, 2. high selectivity to the desired aldehyde and 3. high stereoselectivity in favor of the desired isomer.

In rhodium-catalyzed low-pressure hydroformylation, the use of phosphorus-comprising ligands for stabilizing and/or activating the catalyst metal is known. Suitable phosphorus-comprising ligands are, for example, phosphines, phosphinites, phosphonites, phosphites, phosphoramidites, phosphols and phosphabenzenes. The most widely used ligands at present are triarylphosphines, e.g. triphenylphosphine and sulfonated triphenylphosphine, since these have sufficient stability under the reaction conditions.

WO 00/56451 describes hydroformylation catalysts based on phosphinamidite ligands in which the phosphorus atom together with an oxygen atom to which it is bound forms a 5- to 8-membered heterocycle.

WO 02/083695 describes chelating pnicogen compounds in which at least one pyrrole group is bound via the pyrrole nitrogen to each of the pnicogen atoms. These chelating pnicogen compounds are suitable as ligands for hydroformylation catalysts.

WO 03/018192 describes, inter alia, pyrrole-phosphorus compounds in which at least one substituted pyrrole group and/or pyrrole group integrated into a fused ring system is bound covalently via its pyrrole nitrogen to the phosphorus atom. These compounds display a very good stability when used as ligands in hydroformylation catalysts.

DE-A-103 42 760 describes pnicogen compounds which have two pnicogen atoms and in which pyrrole groups can be bound via a pyrrole nitrogen to both pnicogen atoms and both pnicogen atoms are bound via a methylene group to a bridging group. These pnicogen compounds are suitable as ligands for hydroformylation catalysts.

Chiral catalysts are not described in the abovementioned documents.

It is known that the use of chelating ligands which have two groups capable of coordination has an advantageous effect on the stereoselectivity achieved in asymmetric hydroformylation reactions. Thus, for example, M. M. H. Lambers-Verstappen and J. de Vries in Adv. Synth. Catal. 2003, 345, No. 4, pp. 478-482, describe the rhodium-catalyzed hydroformylation of unsaturated nitriles, but a satisfactory asymmetric hydroformylation was possible only when using asymmetric BINAPHOS ligands.

EP-A-0 503 884 describes an optically active 2′-diphenylphosphino-1,1′-binaphthyl compound substituted in the 2 position, catalysts based on transition metal complexes which have such a compound as ligand and a process for enantioselective silylation using such a catalyst.

EP-A-0 614 870 describes a process for preparing optically active aldehydes by hydroformylation of prochiral 1-olefins in the presence of a rhodium complex comprising an unsymmetrical phosphorus-comprising ligand having a 1,1′-binaphthylene backbone as hydroformylation catalyst. The preparation of the unsymmetrical phosphorus-comprising ligands requires a complicated synthesis. EP-A-0 614 901, EP-A-0 614 902, EP-A-0 614 903, EP-A-0 684 249 and DE-A-198 53 748 describe unsymmetrical phosphorus-comprising ligands having a comparable structure.

WO 93/03839 (EP-B-0 600 020) describes an optically active metal-ligand complex comprising an optically active pnicogen compound as ligand as catalyst and also processes for asymmetric synthesis in the presence of such a catalyst.

The German patent application P 103 55 066.6, which is not a prior publication, relates to a process for asymmetric synthesis in the presence of a chiral catalyst comprising at least one complex of a metal of transition group VIII with ligands capable of dimerization via noncovalent bonds, such catalysts and their use.

It is an object of the present invention to provide chiral compounds and catalysts based thereon which are suitable for preparing chiral compounds with high stereoselectivity and high reactivity. These catalysts should, in particular, be suitable for the hydroformylation of olefins with good stereoselectivity and high reactivity.

We have accordingly found chelating phosphorus compounds of the general formula I

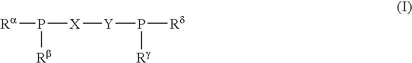

where
R^{α} and R^{β} are each, independently of one another, 5- to 7-membered heterocyclic groups which are bound via a ring nitrogen to the phosphorus atom or R^{α} and R^{β} together with the phosphorus atom to which they are bound form a 5- to 7-membered heterocycle which further comprises an optionally substituted nitrogen atom and a further heteroatom selected from among oxygen and optionally substituted nitrogen which are both bound directly to the phosphorus atom,
R^{γ} and R^{δ} are each, independently of one another, alkyl, cycloalkyl, heterocycloalkyl, aryl or hetaryl, where the alkyl radicals may have 1, 2, 3, 4 or 5 substituents selected from among cycloalkyl, heterocycloalkyl, aryl, hetaryl, alkoxy, cycloalkoxy, heterocycloalkoxy, aryloxy, hetaryloxy, hydroxy, thiol, polyalkylene oxide, polyalkyleneimine, COOH, carboxylate, SO₃H, sulfonate, NE¹E², NE¹E²E³X⁻, halogen, nitro, acyl and cyano, where E¹, E² and E³ are identical or different radicals selected from among hydrogen, alkyl, cycloalkyl and aryl and X⁻ is an anion equivalent,
   and the cycloalkyl, heterocycloalkyl, aryl and hetaryl radicals R^{γ} and R^{δ} may have 1, 2, 3, 4 or 5 substituents selected from among alkyl and the substituents mentioned above for the alkyl radicals R^{γ} and R^{δ}, and
X is O, S, SiR^{ε}R^{ξ} or NR^{η}, where R^{ε}, R^{ξ} and R^{η} are each, independently of one another, hydrogen, alkyl, cycloalkyl, heterocycloalkyl, aryl or hetaryl, and
Y is a chiral divalent bridging group.

For the purposes of the present invention, “chiral compounds” are compounds having at least one center of chirality (i.e. at least one asymmetric atom, in particular at least one asymmetric C atom or P atom), having an axis of chirality, a plane of chirality or a screw structure.

For the purposes of the present invention, the term “chiral catalyst” is to be interpreted broadly. It comprises both catalysts which have at least one chiral ligand and catalysts which have ligands which are achiral per se but have point chirality, axial chirality, planar chirality or helicity owing to the arrangement of the ligands as a result of noncovalent interactions and/or the arrangement of the ligands in complexed form.

“Achiral compounds” are compounds which are not chiral.

A “prochiral compound” is a compound having at least one prochiral center. The term “asymmetric synthesis” refers to a reaction in which a compound having at least one center of chirality, axis of chirality, plane of chirality or screw structure is produced from a compound having at least one prochiral center, with the stereoisomeric products being formed in unequal amounts.

“Stereoisomers” are compounds having the same constitution but a different arrangement of atoms in three-dimensional space.

“Enantiomers” are stereoisomers which are mirror images of one another. The “enantiomeric excess” (ee) achieved in an asymmetric synthesis is calculated according to the following formula: ee[%]=(R−S)/(R+S)×100. R and S are the descriptors according to the CIP system for the two enantiomers and indicate the absolute configuration at the asymmetric atom. The enantiomerically pure compound (ee=100%) is also referred to as “homochiral compound”.

The process of the invention leads to products which are enriched in a particular stereoisomer. The “enantiomeric excess” (ee) achieved is generally at least 20%, preferably at least 50%, in particular at least 80%.

“Diastereomers” are stereoisomers which are not enantiomers of one another.

In the following, the expression “alkyl” comprises straight-chain and branched alkyl groups. These groups are preferably straight-chain or branched C₁-C₂₀-alkyl groups, more preferably C₁-C₁₂-alkyl groups, particularly preferably C₁-C₈-alkyl groups and very particularly preferably C₁-C₄-alkyl groups. Examples of alkyl groups are, in particular, methyl, ethyl, propyl, isopropyl, n-butyl, 2-butyl, sec-butyl, tert-butyl, n-pentyl, 2-pentyl, 2-methylbutyl, 3-methylbutyl, 1,2-dimethylpropyl, 1,1-dimethylpropyl, 2,2-dimethyl-propyl, 1-ethylpropyl, n-hexyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethyl-butyl, 3,3-dimethylbutyl, 1,1,2-trimethylpropyl, 1,2,2-trimethylpropyl, 1-ethylbutyl, 2-ethylbutyl, 1-ethyl-2-methylpropyl, n-heptyl, 2-heptyl, 3-heptyl, 2-ethylpentyl, 1-propylbutyl, n-octyl, 2-ethylhexyl, 2-propylheptyl, nonyl, decyl.

The expression “alkyl” also comprises substituted alkyl groups which can generally bear 1, 2, 3, 4 or 5 substituents, preferably 1, 2 or 3 substituents and particularly preferably 1 substituent, selected from among cycloalkyl, aryl, hetaryl, halogen, NE¹E², NE¹E²E³⁺, COOH, carboxylate, —SO₃H and sulfonate.

For the purposes of the present invention, the expression “alkylene” refers to straight-chain or branched alkanediyl groups having from 1 to 4 carbon atoms.

For the purposes of the present invention, the expression “cycloalkyl” comprises unsubstituted and substituted cycloalkyl groups, preferably C₅-C₇-cycloalkyl groups such as cyclopentyl, cyclohexyl or cycloheptyl, which if they are substituted can generally bear 1, 2, 3, 4 or 5 substituents, preferably 1, 2 or 3 substituents and particularly preferably 1 substituent, selected from among alkyl, alkoxy and halogen.

For the purposes of the present invention, the expression “heterocycloalkyl” comprises saturated, cycloaliphatic groups which generally have from 4 to 7, preferably 5 or 6, ring atoms and in which 1 or 2 of the ring carbons are replaced by heteroatoms, preferably heteroatoms selected from among the elements oxygen, nitrogen and sulfur, and which may optionally be substituted. If they are substituted, these heterocycloaliphatic groups can bear 1, 2 or 3 substituents, preferably 1 or 2 substituents, particularly preferably 1 substituent, selected from among alkyl, aryl, COOR^{f}, COO⁻M⁺ and NE¹E², preferably alkyl. Examples of such heterocycloaliphatic groups are pyrrolidinyl, piperidinyl, 2,2,6,6-tetramethylpiperidinyl, imidazolidinyl, pyrazolidinyl, oxazolidinyl, morpholidinyl, thiazolidinyl, isothiazolidinyl, isoxazolidinyl, piperazinyl, tetrahydrothiophenyl, tetrahydrofuranyl, tetrahydropyranyl, dioxanyl.

For the purposes of the present invention, the expression “aryl” comprises unsubstituted and substituted aryl groups, and preferably refers to phenyl, tolyl, xylyl, mesityl, naphthyl, fluorenyl, anthracenyl, phenanthrenyl or naphthacenyl, particularly preferably phenyl or naphthyl. If they are substituted, these aryl groups can generally bear 1, 2, 3, 4 or 5 substituents, preferably 1, 2 or 3 substituents and particularly preferably 1 substituent, selected from among alkyl, alkoxy, carboxyl, carboxylate, trifluoromethyl, —SO₃H, sulfonate, NE¹E², alkylene-NE¹E², nitro, cyano and halogen.

For the purposes of the present invention, the expression “hetaryl” comprises unsubstituted or substituted, heterocycloaromatic groups, preferably the groups pyridyl, quinolinyl, acridinyl, pyridazinyl, pyrimidinyl, pyrazinyl and the subgroup referred to as “pyrrole group”. If they are substituted, these heterocycloaromatic groups can generally bear 1, 2 or 3 substituents selected from among alkyl, alkoxy, carboxyl, carboxylate, —SO₃H, sulfonate, NE¹E², alkylene-NE¹E², trifluoromethyl and halogen.

For the purposes of the present invention, the expression “pyrrole group” refers to a series of unsubstituted or substituted, heterocycloaromatic groups which are derived structurally from the pyrrole skeleton and comprise a pyrrole nitrogen in the heterocycle, which can be covalently bound to other atoms, for example a pnicogen atom. The expression “pyrrole group” thus comprises the unsubstituted or substituted groups pyrrolyl, imidazolyl, pyrazolyl, indolyl, purinyl, indazolyl, benzotriazolyl, 1,2,3-triazolyl, 1,3,4-triazolyl and carbazolyl, which if they are substituted can generally bear 1, 2 or 3 substituents, preferably 1 or 2 substituents, particularly preferably 1 substituent, selected from among alkyl, alkoxy, acyl, carboxyl, carboxylate, —SO₃H, sulfonate, NE¹E², alkylene-NE¹E², trifluoromethyl and halogen. A preferred substituted indolyl group is the 3-methylindolyl group.

Accordingly, the expression “bispyrrole group” as used for the purposes of the present invention comprises divalent groups of the formula

Py-I-Py,

comprising two pyrrole groups which are joined by a direct chemical bond or via an alkylene, oxa, thio, imino, silyl or alkylimino group, for example the bisindolediyl group of the formula

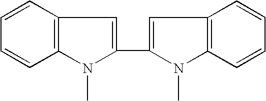

as an example of a bispyrrole group comprising two directly linked pyrrole groups, in this case indolyl, or the bispyrrolediylmethane group of the formula

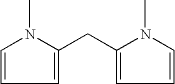

as an example of a bispyrrole group comprising two pyrrole groups, in this case pyrrolyl, linked via a methylene group. As in the case of the pyrrole groups, the bispyrrole groups, too, can be unsubstituted or substituted and, it they are substituted, generally bear 1, 2 or 3 substituents, preferably 1 or 2 substituents, in particular 1 substituent, selected from among alkyl, alkoxy, carboxyl, carboxylate, —SO₃H, sulfonate, NE¹E², alkylene-NE¹E², trifluoromethyl and halogen per pyrrole group unit. In these indications of the number of possible substituents, the link between the pyrrole group units via a direct chemical bond or via the abovementioned groups is not regarded as substitution.

For the purposes of the present invention, carboxylate and sulfonate are preferably a derivative of a carboxylic acid function or a sulfonic acid function, in particular a metal carboxylate or sulfonate, a carboxylic ester or sulfonic ester function or a carboxamide or sulfonamide function. Such functions include, for example, the esters with C₁-C₄-alkanols such as methanol, ethanol, n-propanol, isopropanol, n-butanol, sec-butanol and tert-butanol. They also include primary amides and their N-alkyl and N,N-dialkyl derivatives.

What has been said above with regard to the expressions “alkyl”, “cycloalkyl”, “aryl”, “heterocycloalkyl” and “hetaryl” apply analogously to the expressions “alkoxy”, “cycloalkoxy”, “aryloxy”, “heterocycloalkoxy” and “hetaryloxy”.

For the purposes of the present invention, the expression “acyl” refers to alkanoyl or aroyl groups which generally have from 2 to 11, preferably from 2 to 8, carbon atoms, for example the acetyl, propanoyl, butanoyl, pentanoyl, hexanoyl, heptanoyl, 2-ethylhexanoyl, 2-propylheptanoyl, benzoyl or naphthoyl group.

The groups NE¹E², NE⁴E⁵, NE⁷E⁸, NE¹⁰E¹¹, NE¹³E¹⁴, NE¹⁶E¹⁷ and NE¹⁹E²⁰ are preferably N,N-dimethylamino, N,N-diethylamino, N,N-dipropylamino, N,N-diisopropyl-amino, N,N-di-n-butylamino, N,N-di-t-butylamino, N,N-dicyclohexylamino or N,N-diphenylamino.

Halogen is fluorine, chlorine, bromine or iodine, preferably fluorine, chlorine or bromine.

M⁺ is a cation equivalent, i.e. a monovalent cation or the part of a polyvalent cation corresponding to a single positive charge. The cation M⁺ serves merely as counterion to balance the charge of negatively charged substituent groups such as the COO or sulfonate group and can in principle be chosen freely. Preference is therefore given to using alkali metal ions, in particular Na⁺, K⁺, Li⁺ ions, or onium ions such as ammonium, monoalkylammonium, dialkylammonium, trialkylammonium, tetraalkylammonium, phosphonium, tetraalkylphosphonium or tetraarylphosphonium ions.

An analogous situation applies to the anion equivalent X⁻ which serves merely as counterion to positively charged substituent groups such as ammonium groups and can be selected freely from among monovalent anions and the parts of polyvalent anions corresponding to a single negative charge. Suitable anions are, for example, halide ions X⁻, e.g. chloride and bromide. Preferred anions are sulfate and sulfonate, e.g. SO₄²⁻, tosylate, trifluoromethanesulfonate and methylsulfonate.

x is an integer from 1 to 240, preferably an integer from 3 to 120.

Fused ring systems can be aromatic, hydroaromatic and cyclic compounds joined by fusion. Fused ring systems comprise two, three or more than three rings. Depending on the way in which the rings are joined in fused ring systems, a distinction is made between ortho-fusion, i.e. each ring shares an edge, or two atoms, with each adjacent ring, and peri-fusion in which a carbon atom belongs to more than two rings. Among fused ring systems, preference is given to ortho-fused ring systems.

In a first embodiment, the substituents R^{α} and R^{β} in the chelating phosphorus compounds of the general formula I are heteroatom-comprising groups which are bound via an optionally substituted nitrogen atom to the phosphorus atom, with R^{α} and R^{β} not being joined to one another. R^{α} and R^{β} are then preferably pyrrole groups bound via the pyrrole nitrogen to the phosphorus atom. The meaning of the term “pyrrole group” here corresponds to the definition given at the outset.

Preference is given to chelating phosphorus compounds in which the radicals R^{α} and R^{β} are selected independently from among groups of the formulae II.a to II.k

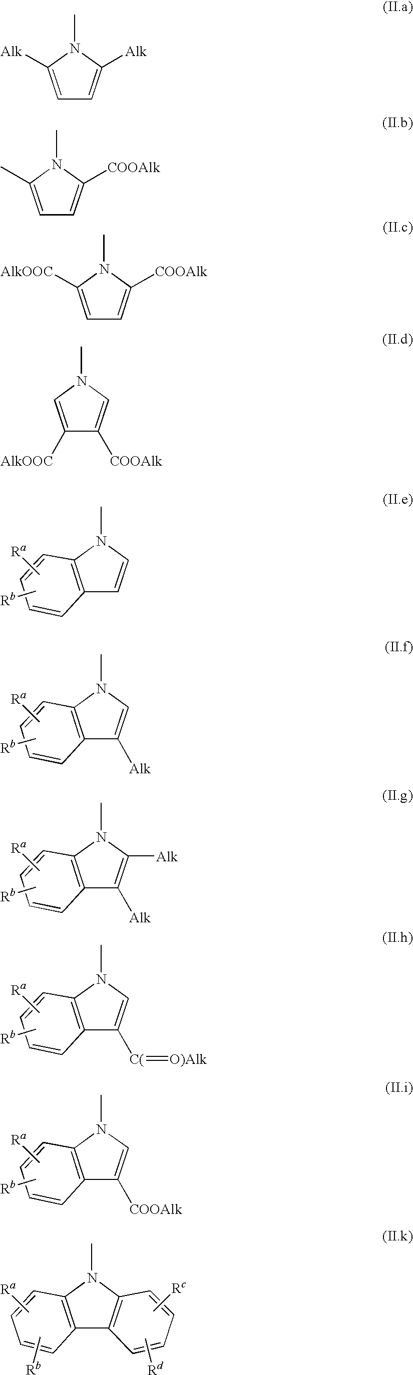

where

Alk is a C₁-C₄-alkyl group and
R^{a}, R^{b}, R^{c} and R^{d} are each, independently of one another, hydrogen, C₁-C₄-alkyl, C₁-C₄-alkoxy, acyl, halogen, trifluoromethyl, C₁-C₄-alkoxycarbonyl or carboxyl.

Particular preference is given to at least one of the radicals R^{α} and R^{β} being an unsubstituted or substituted indolyl group which is selected, in particular, from among the groups II.e to II.i.

In the compounds of the formulae II.e to II.i, the radicals R^{a} and R^{b} are preferably selected independently from among hydrogen, C₁-C₄-alkyl, C₁-C₄-alkoxy and halogen. When at least one of the radicals R^{a} and R^{b} is C₁-C₄-alkyl, then it is especially methyl, ethyl, n-propyl, isopropyl or tert-butyl. When at least one of the radicals R^{a} und R^{b} is C₁-C₄-alkoxy, it is especially methoxy, ethoxy, n-propyloxy, isopropyloxy or tert-butyloxy. When at least one of the radicals R^{a} and R^{b} is halogen, it is especially chlorine.

In a specific embodiment, the radicals R^{a} and R^{b} in the compounds of the formulae II.e to II.i are both hydrogen. In a further specific embodiment, one of the radicals R^{a} and R^{b} in the compounds of the formulae II.e to II.i is hydrogen and the other is a radical other than hydrogen, especially methyl, methoxy or chlorine. The radical other than hydrogen is then preferably present in the 4, 5 or 6 position of the indole skeleton.

Particular preference is given to both the radicals R^{α} and R^{β} being such an unsubstituted or substituted indolyl group.

For the purposes of illustration, some advantageous pyrrole groups are listed below:

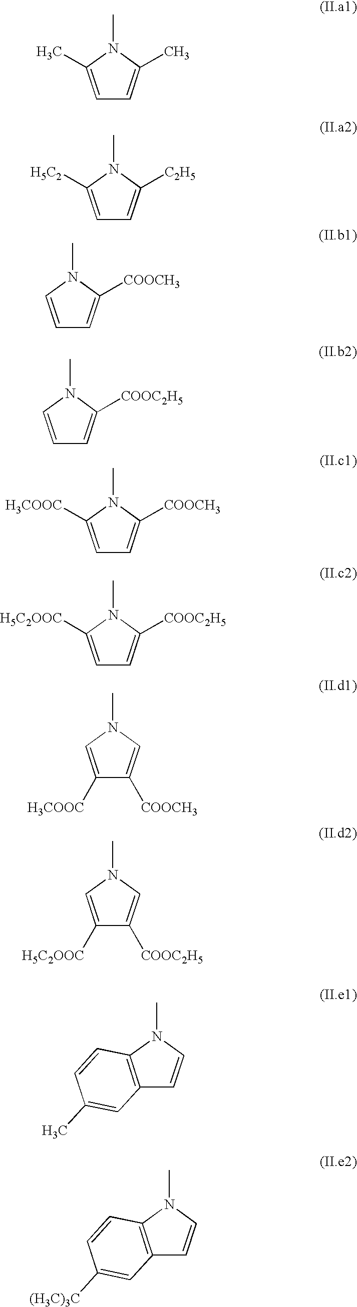

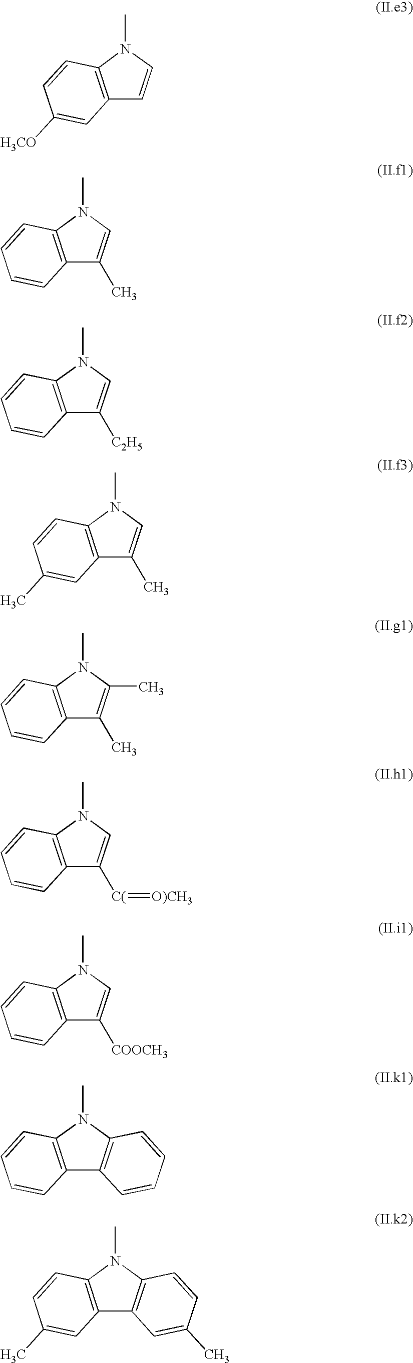

The 3-methylindolyl group (skatolyl group) of the formula II.f1 is particularly advantageous. Hydroformylation catalysts based on ligands having one or more 3-methylindolyl group(s) bound to the phosphorus atom have a particularly high stability and thus give particularly long catalyst lives.

Furthermore, particularly advantageous chelating phosphorus compounds are the ones in which the radicals R^{α} and R^{β} are selected independently from among:

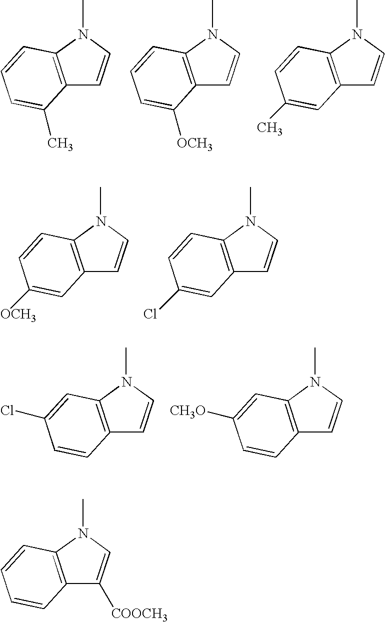

In a further advantageous embodiment of the present invention, R^{α} and R^{β} together with the phosphorus atom to which they are bound form a 5- to 7-membered heterocycle which has two ring heteroatoms bound to the phosphorus atom, with at least one of these ring heteroatoms being an optionally substituted nitrogen atom. Preference is given to the second ring heteroatom bound to the phosphorus atom also being an optionally substituted nitrogen atom. The substituent R^{α} together with the substituent R^{β} then particularly preferably forms a bispyrrole group bound via the pyrrole nitrogens to the phosphorus atom. The meaning of the term “bispyrrole group” here corresponds to the definition given at the outset.

Preference is given to R^{α} and R^{β} together forming a 5- to 7-membered heterocycle which is optionally also fused with one, two, three or four cycloalkyl, heterocycloalkyl, aryl or hetaryl groups where the heterocycle and, if present, the fused-on groups may each bear, independently of one another, one, two, three or four substituents selected from among alkyl, cycloalkyl, heterocycloalkyl, aryl, hetaryl, hydroxy, thiol, polyalkylene oxide, polyalkylenimine, alkoxy, halogen, COOH, carboxylate, SO₃H, sulfonate, NE⁴E⁵, NE⁴E⁵E⁶X⁻, nitro, alkoxycarbonyl, acyl and cyano, where E⁴, E⁵ and E⁶ are identical or different radicals selected from among hydrogen, alkyl, cycloalkyl and aryl and X⁻ is an anion equivalent.

The substituent R^{α} together with the substituent R^{β} preferably forms a divalent group comprising a pyrrole group bound via the pyrrole nitrogen to the phosphorus atom and having the formula

Py-I-W,

where
Py is a pyrrole group,
I is a chemical bond or O, S, SiR¹R², NR³ or optionally substituted C₁-C₁₀-alkylene, preferably CR⁴R⁵,
W is cycloalkyloxy or cycloalkylamino, aryloxy or arylamino, hetaryloxy or hetaryl-amino
   and
R¹, R², R³, R⁴ and R⁵ are each, independently of one another, hydrogen, alkyl, cycloalkyl, heterocycloalkyl, aryl or hetaryl,
   where the designations used here have the meaning explained at the outset.

Suitable divalent groups of the formula

Py-I-W

are, for example,

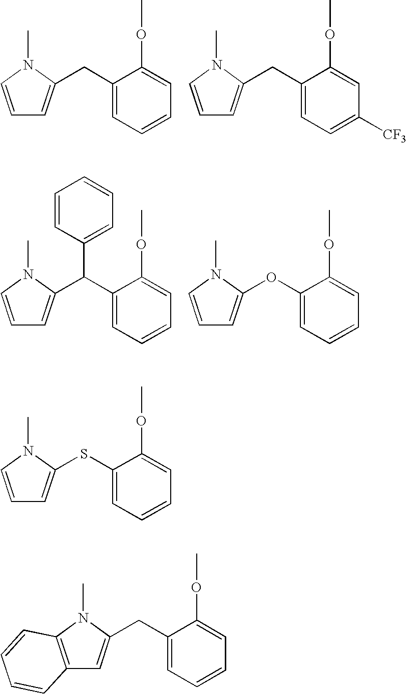

Preference is given to chelating phosphorus compounds in which R^{α} and R^{β} together with the phosphorus atom to which they are bound form a group having one of the formulae II.1 to II.3

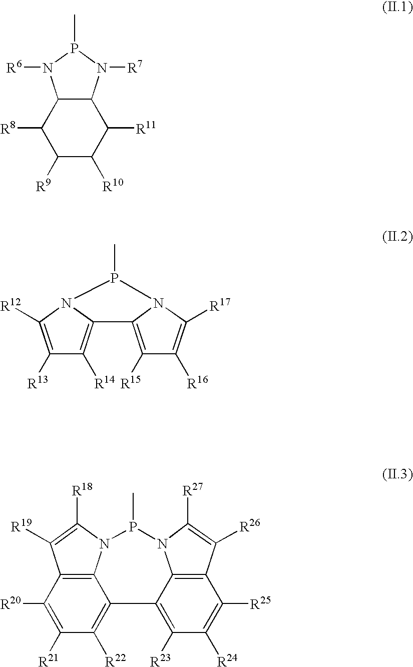

where
R⁶ and R⁷ are each, independently of one another, hydrogen, alkyl, cycloalkyl, aryl, hetaryl, mesylate, tosylate or trifluoromethanesulfonate,
R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶ and R²⁷ are each, independently of one another, hydrogen, alkyl, cycloalkyl, heterocycloalkyl, aryl, hetaryl, W′COOR^{f}, W′COO⁻M⁺, W′(SO₃)R^{f}, W′(SO₃)⁻M⁺, W′PO₃(R^{f})(R^{g}), W′(PO₃)²⁻(M⁺)₂, W′NE¹³E¹⁴, W′(NE¹³E¹⁴E¹⁵)⁺X⁻, W′OR^{f}, W′SR^{f}, (CHR^{g}CH₂O)ₓR^{f}, (CH₂NE¹³)ₓR^{f}, (CH₂CH₂NE¹³)ₓR^{f}, halogen, trifluoromethyl, nitro, acyl or cyano,
   where
W′ is a single bond, a heteroatom, a heteroatom-comprising group or a divalent bridging group having from 1 to 20 bridge atoms,
R^{f}, E¹³, E¹⁴, E¹⁵ are identical or different radicals selected from among hydrogen, alkyl, cycloalkyl and aryl,
R^{g} is hydrogen, methyl or ethyl,
M⁺ is a cation equivalent,
X⁻ is an anion equivalent and
x is an integer from 1 to 240,
   where two adjacent radicals R⁸ to R²⁷ together with the carbon atoms of the ring to which they are bound may also form a fused ring system having 1, 2 or 3 further rings.

The radicals R⁶ and R⁷ in the groups of the formula II.1 are preferably selected independently from among hydrogen, C₁-C₄-alkyl, in particular methyl, ethyl, n-propyl, isopropyl, n-butyl and tert-butyl, C₅-C₆-cycloalkyl, in particular cyclohexyl, and aryl, in particular phenyl.

The radicals R⁸, R⁹, R¹⁰ and R¹¹ in the groups of the formula II.1 are preferably each hydrogen.

Chelating pnicogen compounds of the formula I in which R^{α} and R^{β} together with the phosphorus atom form a chiral group of the formula II.1 are particularly preferred.

The radicals R¹², R¹³, R¹⁴, R¹⁵, R¹⁶ and R¹⁷ in the groups of the formula II.2 are preferably each hydrogen.

Preference is also given to groups of the formula II.2 in which R¹² and R¹³ and/or R¹⁶ and R¹⁷ together with the carbon atoms of the pyrrole ring to which they are bound form a fused ring system having 1, 2 or 3 further rings. The further rings are preferably fused-on aromatic rings. The fused-on aromatic rings are preferably benzene or naphthalene. Fused-on benzene rings are preferably unsubstituted or have 1, 2 or 3 substituents, in particular 1 or 2 substituents, which are preferably selected from among alkyl, alkoxy, halogen, SO₃H, sulfonate, NE⁷E⁸, alkylene-NE⁷E⁸, trifluoromethyl, nitro, carboxyl, alkoxycarbonyl, acyl and cyano. Fused-on naphthalenes are preferably unsubstituted or have 1, 2 or 3, in particular 1 or 2, of the substituents mentioned above for the fused-on benzene rings in the ring which is not fused on and/or in the fused-on ring. An alkyl substituent on the fused-on aryls is preferably C₁-C₄-alkyl and in particular methyl, isopropyl or tert-butyl. An alkoxy substituent is preferably C₁-C₄-alkoxy and in particular methoxy. Alkoxycarbonyl is preferably C₁-C₄-alkoxycarbonyl. A halogen substituent is particularly preferably fluorine or chlorine.

The radicals R¹⁸, R¹⁹, R²⁰, R²¹, R²², R²³, R²⁴, R²⁵, R²⁶ and R²⁷ in the groups of the formula II.3 are preferably each hydrogen.

Preference is also given to groups of the formula II.3 in which (R²⁰ and R²¹) or (R²¹ and R²²) and/or (R²³ and R²⁴) or (R²⁴ and R²⁵) together with the carbon atoms of the benzene ring to which they are bound form a fused ring system having 1, 2 or 3 further rings. The further rings are preferably fused-on aromatic rings. The fused-on aromatic rings are preferably benzene or naphthalene. These can, if desired, be substituted as described above for the groups II.2.

For the purposes of illustration, some advantageous groups II.1 to II.3 are listed below:

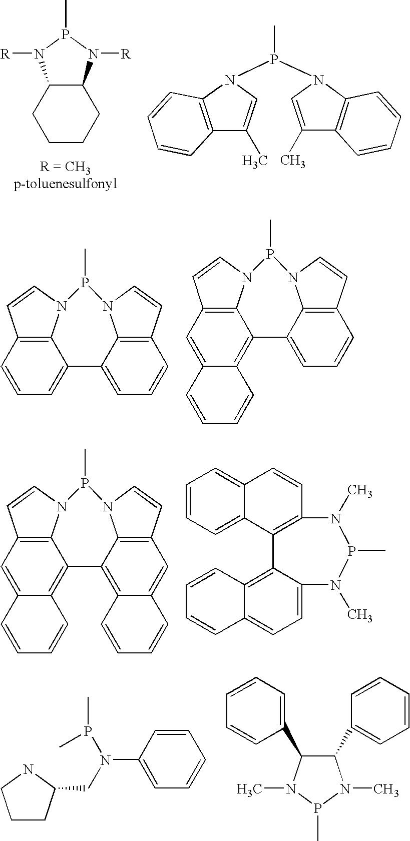

R^{γ} and R^{δ} are preferably, independently of one another, substituents which are not joined to one another. R^{γ} and R^{δ} are then preferably selected independently from among aryl and hetaryl radicals which may bear 1, 2, 3, 4 or 5 of the abovementioned substituents. Preference is given to at least one of the radicals R^{γ} and R^{δ} or both of these radicals being aryl which may bear one, two or three substituents selected from among C₁-C₄-alkyl, C₁-C₄-alkoxy and combinations thereof. Preferred radicals R^{γ} and R^{δ} are then, for example, phenyl, o-tolyl, m-xylyl and 3,5-dimethyl-4-methoxyphenyl.

The bridging group Y is a chiral group which preferably has at least one center of chirality, axis of chirality or plane of chirality.

The bridging groups Y are preferably selected from among groups of the formulae III.a and III.b

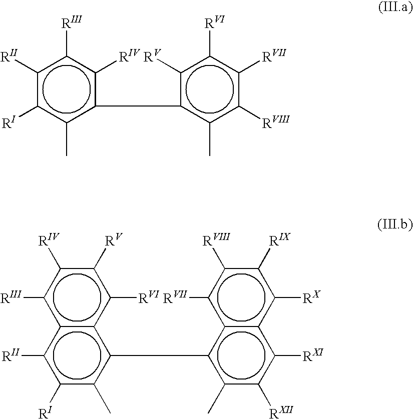

where
R^{I}, R^{I′}, R^{II}, R^{II′}, R^{III}, R^{III′}, R^{IV}, R^{IV′}, R^{V}, R^{VI}, R^{VII}, R^{VIII}, R^{IX}, R^{X}, R^{XI} and R^{XII} are each, independently of one another, hydrogen, alkyl, cycloalkyl, heterocycloalkyl, aryl, hetaryl, hydroxy, thiol, polyalkylene oxide, polyalkylenimine, alkoxy, halogen, SO₃H, sulfonate, NE¹⁰E¹¹, alkylene-NE¹⁰E¹¹, trifluoromethyl, nitro, alkoxycarbonyl, carboxyl, acyl or cyano, where E¹⁰ and E¹¹ are identical or different radicals selected from among hydrogen, alkyl, cycloalkyl and aryl.

Preference is also given to Y being a group of the formula III.a in which R^{IV} and R^{V} are each, independently of one another, C₁-C₄-alkyl or C₁-C₄-alkoxy. R^{IV} and R^{V} are preferably selected from among methyl, ethyl, isopropyl, tert-butyl and methoxy. In these compounds, R^{I}, R^{II}, R^{III}, R^{VI}, R^{VII} and R^{VIII} are preferably each hydrogen.

Preference is also given to Y being a group of the formula III.a in which R^{I} and R^{VIII} are each, independently of one another, C₁-C₄-alkyl or C₁-C₄-alkoxy. R^{I} and R^{VIII} are particularly preferably tert-butyl. In these compounds, R^{II}, R^{III}, R^{IV}, R^{V}, R^{VI}, R^{VII} are each particularly preferably hydrogen. In these compounds, preference is also given to R^{III} and R^{VI} each being, independently of one another, C₁-C₄-alkyl or C₁-C₄-alkoxy. R^{III} and R^{VI} are particularly preferably selected independently from among methyl, ethyl, isopropyl, tert-butyl and methoxy.

Preference is also given to Y being a group of the formula III.a in which R^{II} and R^{VII} are each hydrogen. In these compounds, preference is given to R^{I}, R^{III}, R^{IV}, R^{V}, R^{VI} and R^{VIII} each being, independently of one another, C₁-C₄-alkyl or C₁-C₄-alkoxy. R^{I}, R^{III}, R^{IV}, R^{V}, R^{VI} and R^{VIII} are particularly preferably selected independently from among methyl, ethyl, isopropyl, tert-butyl and methoxy.

Preference is also given to Y being a group of the formula III.b in which R^{I} to R^{XII} are each hydrogen.

Preference is also given to Y being a group of the formula III.b in which R^{I} and R^{XII} are each, independently of one another, C₁-C₄-alkyl or C₁-C₄-alkoxy. In particular, R^{I} and R^{XII} are selected independently from among methyl, ethyl, isopropyl, tert-butyl, methoxy and alkoxycarbonyl, preferably methoxycarbonyl. In these compounds, the radicals R^{II} to R^{XI} are particularly preferably each hydrogen.

For the purposes of illustration, a few suitable ligands are depicted below:

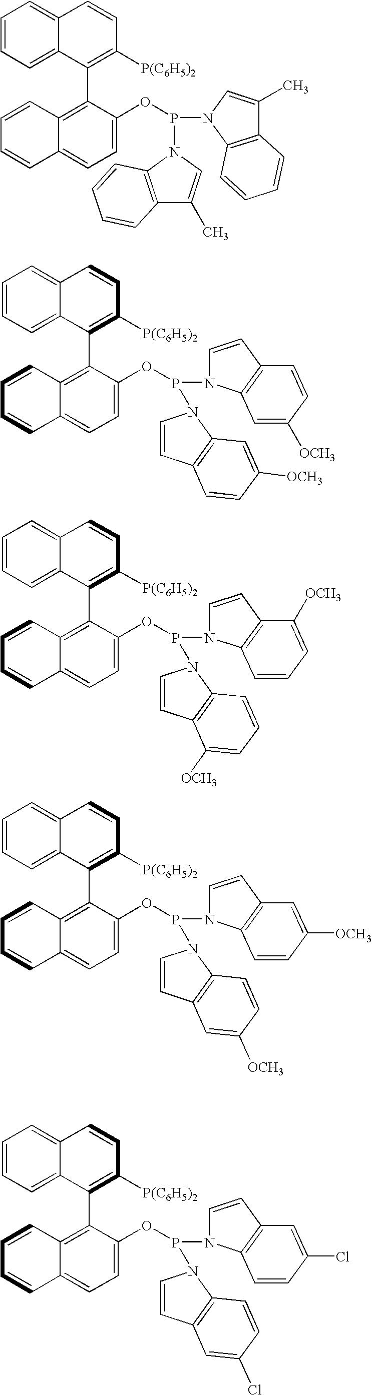

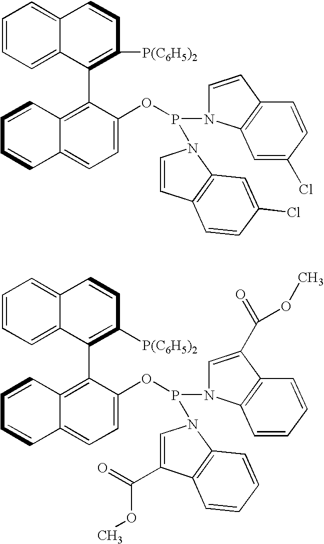

The invention further provides a chiral catalyst comprising at least one complex of a metal of transition group VIII of the Periodic Table of the Elements which comprises at least one chiral chelating phosphorus compound as defined above as ligand.

The chiral catalysts of the invention and chiral catalysts used according to the invention have at least one of the above-described compounds as ligand. In addition to the above-described ligands, they can further comprise at least one additional ligand which is preferably selected from among halides, amines, carboxylates, acetylacetonate, arylsulfonates or alkylsulfonates, hydride, CO, olefins, dienes, cycloolefins, nitriles, N-comprising heterocycles, aromatics and heteroaromatics, ethers, PF₃, phosphols, phosphabenzenes and monodentate, bidentate and polydentate phosphine, phosphinite, phosphonite, phosphoramidite and phosphite ligands.

The transition metal is preferably a metal of transition group I, VI, VII or VIII of the Periodic Table of the Elements. The transition metal is particularly preferably selected from among the metals of transition group VIII (i.e. Fe, Co, Ni, Ru, Rh, Pd, Os, Ir, Pt). In particular, the transition metal is iridium, ruthenium, rhodium, palladium or platinum.

The invention further provides a process for preparing chiral compounds by reacting a prochiral compound comprising at least one ethylenically unsaturated double bond with a substrate in the presence of a chiral catalyst as described above. It is merely necessary for at least one of the ligands used or the catalytically active species to have overall chirality. In general, particular transition metal complexes are formed as catalytically active species under the reaction conditions of the individual processes for preparing chiral compounds. Thus, for example, hydroformylation conditions result in the formation of catalytically active species of the general formula HₓM_{y}(CO)_{z}L_{q}, where M is a transition metal, L is a chelating phosphorus compound and q, x, y, z are integers which depend on the valence and type of the metal and on the number of coordination sites occupied by the ligand L, from the catalysts or catalyst precursors used in the particular case. Preference is given to z and q each having, independently of one another, a value of at least 1, e.g. 1, 2 or 3. The sum of z and q is preferably from 1 to 5. The complexes can, if desired, further comprise at least one of the above-described additional ligands.

The catalytically active species is preferably present as a homogeneous single-phase solution in a suitable solvent. This solution can additionally comprise free ligands.

The process of the invention for preparing chiral compounds is preferably a hydrogenation, hydroformylation, hydrocyanation, carbonylation, hydroacylation (intramolecular and intermolecular), hydroamidation, hydroesterification, hydrosilylation, hydroboration, aminolysis (hydroamination), alcoholysis (hydroxy-alkoxy addition), isomerization, transfer hydrogenation, metathesis, cyclopropanation, aldol condensation, allylic alkylation or [4+2]-cycloaddition (Diels-Alder reaction).

The process of the invention for preparing chiral compounds is particularly preferably a 1,2-addition, in particular a hydrogenation or a 1-hydro-2-carbo-addition. For the purposes of the present invention, a 1,2-addition is an addition onto the two adjacent atoms of a C═X double bond (X═C, heteroatom). A 1-hydro-2-carbo-addition is an addition reaction in which hydrogen is bound to one atom of the double bond and a carbon-comprising group is bound to the other atom of the double bond after the reaction. Double bond isomerizations during the addition are permitted. For the purposes of the present invention, the term 1-hydro-2-carbo-addition does not imply preferential addition of the carbon fragment onto the C₂ atom of unsymmetrical substrates, since the selectivity in respect of the orientation of the addition is generally dependent on the agent to be added on and the catalyst used. “1-Hydro-2-carbo-” thus has the same meaning as “1-carbo-2-hydro-”.

The reaction conditions of the processes of the invention for preparing chiral compounds generally correspond, except for the chiral catalyst used, to those of the corresponding asymmetric processes. Suitable reactors and reaction conditions can thus be taken from the literature relevant to the respective process and adapted routinely by a person skilled in the art. Suitable reaction temperatures are generally in the range from −100 to 500° C., preferably in the range from −80 to 250° C. Suitable reaction pressures are generally in the range from 0.0001 to 600 bar, preferably from 0.5 to 300 bar. The processes can generally be carried out continuously, semicontinuously or batchwise. Suitable reactors for the continuous reaction are known to those skilled in the art and are described, for example, in Ullmanns Enzyklopädie der technischen Chemie, Vol. 1, 3rd edition, 1951, p. 743 ff. Suitable pressure-rated reactors are likewise known to those skilled in the art and are described, for example, in Ullmanns Enzyklopädie der technischen Chemie, Vol. 1, 3rd edition, 1951, p. 769 ff.

The process of the invention can be carried out in a suitable solvent which is inert under the respective reaction conditions. Solvents which are generally suitable are, for example, aromatics such as toluene and xylenes, hydrocarbons or mixtures of hydrocarbons. Further suitable solvents are halogenated, in particular chlorinated, hydrocarbons such as dichloromethane, chloroform or 1,2-dichloroethane. Further solvents are esters of aliphatic carboxylic acids with alkanols, for example acetic esters or Texanol®, ethers such as tert-butyl methyl ether, 1,4-dioxane and tetrahydrofuran and also dimethylformamide. In the case of sufficiently hydrophilic ligands, it is also possible to use alcohols such as methanol, ethanol, n-propanol, isopropanol, n-butanol, isobutanol, ketones such as acetone and methyl ethyl ketone, etc. Furthermore, “ionic liquids” can also be used as solvents. These are liquid salts, for example N,N′-dialkyl-imidazolium salts such as N-butyl-N′-methylimidazolium salts, tetraalkylammonium salts such as tetra-n-butylammonium salts, N-alkylpyridinium salts such as n-butyl-pyridinium salts, tetraalkylphosphonium salts such as trishexyl(tetradecyl)phosphonium salts, e.g. the tetrafluoroborates, acetates, tetrachloroaluminates, hexafluoro-phosphates, chlorides and tosylates. A starting material, product or by-product of the respective reaction can also be used as solvent.

Prochiral ethylenically unsaturated compounds which can be used for the process of the invention are in principle all prochiral compounds which comprise one or more ethylenically unsaturated carbon-carbon or carbon-heteroatom double bonds. These include prochiral olefins in general (hydroformylation, intermolecular hydroacylation, hydrocyanation, hydrosilylation, carbonylation, hydroamidation, hydroesterification, aminolysis, alcoholysis, cyclopropanation, hydroboration, Diels-Alder reaction, metathesis), unsubstituted and substituted aldehydes (intramolecular hydroacylation, aldol condensation, allylic alkylation), ketones (hydrogenation, hydrosilylation, aldol condensation, transfer hydrogenation, allylic alkylation and imines (hydrogenation, hydrosilylation, transfer hydrogenation, Mannich reaction).

Suitable prochiral ethylenically unsaturated olefins are compounds of the formula

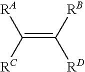

in general, where R^{A} and R^{B} and/or R^{C} and R^{D} are radicals having differing definitions. It goes without saying that the substrates reacted with the prochiral ethylenically unsaturated compound for the preparation according to the invention of chiral compounds and sometimes also the stereoselectivity in respect of the addition of a particular substituent onto a particular carbon atom of the C—C double bond are selected so that at least one chiral carbon atom results.

R^{A}, R^{B}, R^{C} and R^{D} are preferably selected independently, taking the abovementioned condition into account, from among hydrogen, alkyl, cycloalkyl, heterocycloalkyl, aryl, hetaryl, alkoxy, cycloalkoxy, heterocycloalkoxy, aryloxy, hetaryloxy, hydroxy, thiol, polyalkylene oxide, polyalkylenimine, COOH, carboxylate, SO₃H, sulfonate, NE¹⁶E¹⁷, NE¹⁶E¹⁷E¹⁸X⁻, halogen, nitro, acyl, acyloxy and cyano, where E¹⁶, E¹⁷ and E¹⁸ are identical or different radicals selected from among hydrogen, alkyl, cycloalkyl and aryl and X⁻ is an anion equivalent,

where the alkyl radicals may have 1, 2, 3, 4, 5 or more substituents selected from among cycloalkyl, heterocycloalkyl, aryl, hetaryl, alkoxy, cycloalkoxy, heterocyclo-alkoxy, aryloxy, hetaryloxy, hydroxy, thiol, polyalkylene oxide, polyalkylenimine, COOH, carboxylate, SO₃H, sulfonate, NE¹⁹E²⁰, NE¹⁹E²⁰E²¹X⁻, halogen, nitro, acyl, acyloxy and cyano, where E¹⁹, E²⁰ and E²¹ are identical or different radicals selected from among hydrogen, alkyl, cycloalkyl and aryl and X⁻ is an anion equivalent,
and the cycloalkyl, heterocycloalkyl, aryl and hetaryl radicals R^{A}, R^{B}, R^{C} and R^{D} may each have 1, 2, 3, 4, 5 or more substituents selected from among alkyl and the substituents mentioned above for the alkyl radicals R^{A}, R^{B}, R^{C} and R^{D}, or
two or more of the radicals R^{A}, R^{B}, R^{C} and R^{D} together with the C—C double bond to which they are bound form a monocyclic or polycyclic compound.

Suitable prochiral olefins are olefins which have at least 4 carbon atoms and terminal or internal double bonds and have a linear, branched or cyclic structure.

Suitable α-olefins are, for example, 1-butene, 1-pentene, 1-hexene, 1-heptene, 1-octene, 1-nonene, 1-decene, 1-undecene, 1-dodecene, 1-octadecene, etc.

Suitable linear (straight-chain) internal olefins are preferably C₄-C₂₀-olefins such as 2-butene, 2-pentene, 2-hexene, 3-hexene, 2-heptene, 3-heptene, 2-octene, 3-octene, 4-octene, etc.

Suitable branched, internal olefins are preferably C₄-C₂₀-olefins such as 2-methyl-2-butene, 2-methyl-2-pentene, 3-methyl-2-pentene, branched, internal heptene mixtures, branched, internal octene mixtures, branched, internal nonene mixtures, branched, internal decene mixtures, branched, internal undecene mixtures, branched, internal dodecene mixtures, etc.

Further suitable olefins for hydroformylation are C₅-C₈-cycloalkenes such as cyclopentene, cyclohexene, cycloheptene, cyclooctene and their derivatives, e.g. their C₁-C₂₀-alkyl derivatives having from 1 to 5 alkyl substituents.

Further suitable olefins for hydroformylation are vinylaromatics such as styrene, α-methylstyrene, 4-isobutylstyrene, etc., 2-vinyl-6-methoxynaphthalene, 3-ethenyl-phenyl phenyl ketone, 4-ethenylphenyl 2-thienyl ketone, 4-ethenyl-2-fluorobiphenyl, 4-(1,3-dihydro-1-oxo-2H-isoindol-2-yl)styrene, 2-ethenyl-5-benzoylthiophene, 3-ethenylphenyl phenyl ether, propenylbenzene, 2-propenylphenol, isobutyl-4-propenylbenzene, phenyl vinyl ether and cyclic enamides, e.g. 2,3-dihydro-1,4-oxazines such as 2,3-dihydro-4-tert-butoxycarbonyl-1,4-oxazine. Further suitable olefins for hydroformylation are α,β-ethylenically unsaturated mono-carboxylic and/or dicarboxylic acids, their esters, monoesters and amides, e.g. acrylic acid, methacrylic acid, maleic acid, fumaric acid, crotonic acid, itaconic acid, methyl 3-pentenoate, methyl 4-pentenoate, methyl oleate, methyl acrylate, methyl methacrylate, unsaturated nitriles such as 3-pentenenitrile, 4-pentenenitrile, acrylonitrile, vinyl ethers such as vinyl methyl ether, vinyl ethyl ether, vinyl propyl ether, etc., vinyl chloride, allyl chloride, C₃-C₂₀-alkenols, -alkenediols and -alkadienols, e.g. allyl alcohol, hex-1-en-4-ol, oct-1-en-4-ol, 2,7-octadienol-1. Further suitable substrates are dienes or polyenes having isolated or conjugated double bonds. These include, for example, 1,3-buta-diene, 1,4-pentadiene, 1,5-hexadiene, 1,6-heptadiene, 1,7-octadiene, 1,8-nonadiene, 1,9-decadiene, 1,10-undecadiene, 1,11-dodecadiene, 1,12-tridecadiene, 1,13-tetra-decadiene, vinylcyclohexene, dicyclopentadiene, 1,5,9-cyclooctatriene and also homopolymers and copolymers of butadiene.

Further prochiral ethylenically unsaturated compounds which are important as building blocks for syntheses are, for example, p-isobutylstyrene, 2-vinyl-6-methoxy-naphthalene, 3-ethenylphenyl phenyl ketone, 4-ethenylphenyl 2-thienyl ketone, 4-ethenyl-2-fluorobiphenyl, 4-(1,3-dihydro-1-oxo-2H-isoindol-2-yl)styrene, 2-ethenyl-5-benzoylthiophene, 3-ethenylphenyl phenyl ether, propenylbenzene, 2-propenyl-phenol, isobutyl-4-propenylbenzene, phenyl vinyl ether and cyclic enamides, e.g. 2,3-dihydro-1,4-oxazines such as 2,3-dihydro-4-tert-butoxycarbonyl-1,4-oxazine.

The abovementioned olefins can be used individually or in the form of mixtures.

In a preferred embodiment, the chiral catalysts of the invention and chiral catalysts used according to the invention are prepared in situ in the reactor used for the reaction. However, the catalysts of the invention can, if desired, also be prepared separately and be isolated by conventional methods. For the in-situ preparation of the catalysts of the invention, it is possible, for example, to react at least one ligand used according to the invention, a compound or a complex of a transition metal, if appropriate at least one further additional ligand and if appropriate an activating agent in an inert solvent under the conditions of the respective reaction (e.g. under hydroformylation conditions, hydrocyanation conditions, etc.). Suitable activating agents are, for example, Brönsted acids, Lewis acids such as BF₃, AlCl₃, ZnCl₂ and Lewis bases.

Suitable catalyst precursors are quite generally transition metals, transition metal compounds and transition metal complexes.

Suitable rhodium compounds or complexes are, for example, rhodium(II) and rhodium(III) salts such as rhodium(III) chloride, rhodium(III) nitrate, rhodium(III) sulfate, potassium rhodium sulfate, rhodium(II) or rhodium(III) carboxylate, rhodium(II) and rhodium(III) acetate, rhodium(III) oxide, salts of rhodic(III) acid, trisammonium hexachlororhodate(III), etc. Rhodium complexes such as Rh₄(CO)₁₂, biscarbonyl-rhodium acetylacetonate, acetylacetonatobis(ethylene)rhodium(I), etc., are also suitable.

Ruthenium salts or compounds are likewise suitable. Suitable ruthenium salts are, for example, ruthenium(III) chloride, ruthenium(IV), ruthenium(VI) or ruthenium(VIII) oxide, alkali metal salts of oxo acids of ruthenium, e.g. K₂RuO₄ or KRuO₄, or complexes such as RuHCl(CO)(PPh₃)₃, (Ru(p-cymene)Cl)₂, (Ru(benzene)Cl)₂, (COD)Ru(methallyl)₂, Ru(acac)₃. Metal carbonyls of ruthenium such as dodecacarbonyltriruthenium or octadecacarbonylhexaruthenium or mixed forms in which CO has partly been replaced by ligands of the formula PR₃, e.g. Ru(CO)₃(PPh₃)₂, can also be used in the process of the invention.

Suitable iron compounds are, for example, iron(III) acetate and iron(III) nitrate and also the carbonyl complexes of iron.

Suitable nickel compounds are nickel fluoride and nickel sulfate. A nickel complex suitable for preparing a nickel catalyst is, for example, bis(1,5-cyclooctadiene)nickel(0).

Further suitable catalyst precursors are carbonyl complexes of iridium and osmium, osmium halides, osmium octoate, palladium hydrides and halides, platinic acid, iridium sulfate, etc.

The abovementioned and further suitable transition metal compounds and complexes are known in principle and are adequately described in the literature or they can be prepared by a person skilled in the art using methods analogous to those employed for the known compounds.

In general, the metal concentration in the reaction medium is in the range from about 1 to 10 000 ppm. The molar ratio of monopnicogen ligand to transition metal is generally in the range from about 0.5:1 to 1000:1, preferably from 1:1 to 500:1.

The use of supported catalysts is also useful. For this purpose, the above-described catalysts can be immobilized on a suitable support, e.g. glass, silica gel, synthetic resins, polymers, etc., in an appropriate way, e.g. by binding via functional groups suitable as anchor groups, adsorption, grafting, etc. They are then also suitable for use as solid-phase catalysts.

In a first preferred embodiment, the process of the invention is a hydrogenation (1,2-H,H-addition). In this reaction, a prochiral compound comprising at least one ethylenically unsaturated double bond is reacted with hydrogen in the presence of a chiral catalyst as described above to give corresponding chiral compounds having a single bond. Prochiral olefins give chiral carbon-comprising compounds, prochiral ketones give chiral alcohols and prochiral imines give chiral amines.

In a further preferred embodiment, the process of the invention is a reaction with carbon monoxide and hydrogen, hereinafter referred to as hydroformylation.

The hydroformylation can be carried out in the presence of one of the abovementioned solvents.

The molar ratio of mono(pseudo)pnicogen ligand to metal of transition group VIII is generally in the range from about 1:1 to 1000:1, preferably from 2:1 to 500:1.

Preference is given to a process in which the hydroformylation catalyst is prepared in situ by reacting at least one ligand which can be used according to the invention, a compound or a complex of a transition metal and if appropriate an activating agent in an inert solvent under the hydroformylation conditions.

The transition metal is preferably a metal of transition group VIII of the Periodic Table of the Elements, particularly preferably cobalt, ruthenium, iridium, rhodium or palladium. Particular preference is given to using rhodium.

The composition of the synthesis gas comprising carbon monoxide and hydrogen used in the process of the invention can be varied within a wide range. The molar ratio of carbon monoxide to hydrogen is generally from about 5:95 to 70:30, preferably from about 40:60 to 60:40. Particular preference is given to using a molar ratio of carbon monoxide to hydrogen in the region of about 1:1.

The temperature in the hydroformylation reaction is generally in the range from about 20 to 180° C., preferably about 50 to 150° C. The pressure is generally in the range from about 1 to 700 bar, preferably 1 to 600 bar, in particular 1 to 300 bar. The reaction pressure may be varied as a function of the activity of the hydroformylation catalyst of the invention used. The catalysts of the invention based on phosphorus-comprising compounds generally allow a reaction in the region of low pressures, for example in the range from 1 to 100 bar.

The hydroformylation catalysts used according to the invention and the hydroformylation catalysts of the invention can be separated off from the output from the hydroformylation reaction by conventional methods known to those skilled in the art and can generally be reused for the hydroformylation.

The asymmetric hydroformylation according to the process of the invention displays a high stereoselectivity. Advantageously, the catalysts of the invention and the catalysts used according to the invention also generally display a high regioselectivity. Furthermore, the catalysts generally have a high stability under the hydroformylation conditions, so that their use generally makes it possible to achieve longer operating lives of the catalyst than when using catalysts based on conventional chelating ligands known from the prior art. The catalysts of the invention and used according to the invention also advantageously display a high activity, so that the corresponding aldehydes or alcohols are generally obtained in good yields.

A further important 1-hydro-2-carbo-addition is the reaction with hydrogen cyanide, hereinafter referred to as hydrocyanation.

The catalysts used for the hydrocyanation, too, comprise complexes of a metal of transition group VIII, in particular cobalt, nickel, ruthenium, rhodium, palladium, platinum, preferably nickel, palladium or platinum and very particularly preferably nickel. The preparation of the metal complexes can be carried out as described above. The same applies to the in-situ preparation of the hydrocyanation catalysts of the invention. Hydrocyanation processes are described in J. March, Advanced Organic Chemistry, 4th edition, pp. 811-812, which is hereby incorporated by reference.

In a further preferred embodiment, the 1-hydro-2-carbo-addition is a reaction with carbon monoxide and at least one compound having a nucleophilic group, hereinafter referred to as carbonylation.

The carbonylation catalysts, too, comprise complexes of a metal of transition group VIII, preferably nickel, cobalt, iron, ruthenium, rhodium or palladium, in particular palladium. The preparation of the metal complexes can be carried out as described above. The same applies to the in-situ preparation of the carbonylation catalysts of the invention.

The compounds having a nucleophilic group are preferably selected from among water, alcohols, thiols, carboxylic esters, primary and secondary amines.

A preferred carbonylation reaction is the conversion of olefins into carboxylic acids by means of carbon monoxide and water (hydrocarboxylation).

The carbonylation can be carried out in the presence of activating agents. Suitable activating agents are, for example, Brönsted acids, Lewis acids such as BF₃, AlCl₃, ZnCl₂ and Lewis bases.

A further important 1,2-addition is hydroacylation. In asymmetric intramolecular hydroacylation, an unsaturated aldehyde is reacted to give optically active cyclic ketones. In asymmetric intermolecular hydroacylation, a prochiral olefin is reacted with an acyl halide in the presence of a chiral catalyst as described above to give chiral ketones. Suitable hydroacylation processes are described in J. March, Advanced Organic Chemistry, 4th edition, p. 811, which is hereby incorporated by reference.

A further important 1,2-addition is hydroamidation. Here, a prochiral compound comprising at least one ethylenically unsaturated double bond is reacted with carbon monoxide and ammonia, a primary amine or a secondary amine in the presence of a chiral catalyst as described above to give chiral amides.

A further important 1,2-addition is hydroesterification. Here, a prochiral compound comprising at least one ethylenically unsaturated double bond is reacted with carbon monoxide and an alcohol in the presence of a chiral catalyst as described above to give chiral esters.

A further important 1,2-addition is hydroboration. Here, a prochiral compound comprising at least one ethylenically unsaturated double bond is reacted with borane or a borane source in the presence of a chiral catalyst as described above to give chiral trialkylboranes which can be oxidized to primary alcohols (e.g. by means of NaOH/H₂O₂) or to carboxylic acids. Suitable hydroboration processes are described in J. March, Advanced Organic Chemistry, 4th edition, pp. 783-789, which is hereby incorporated by reference.

A further important 1,2-addition is hydrosilylation. Here, a prochiral compound comprising at least one ethylenically unsaturated double bond is reacted with a silane in the presence of a chiral catalyst as described above to give chiral compounds functionalized with silyl groups. Prochiral olefins result in chiral alkanes functionalized with silyl groups. Prochiral ketones result in chiral silyl ethers or silyl alcohols. In the hydrosilylation catalysts, the transition metal is preferably selected from among Pt, Pd, Rh, Ru and Ir. It can be advantageous to use combinations or mixtures of one of the abovementioned catalysts with further catalysts. Suitable additional catalysts include, for example, platinum in finely divided form (“platinum black”), platinum chloride and platinum complexes such as hexachloroplatinic acid or divinyldisiloxane-platinum complexes, e.g. tetramethyldivinyidisiloxane-platinum complexes. Suitable rhodium catalysts are, for example, (RhCl(P(C₆H₅)₃)₃) and RhCl₃. RuCl₃ and IrCl₃ are also suitable. Further suitable catalysts are Lewis acids such as AlCl₃ or TiCl₄ and also peroxides.

Suitable silanes are, for example, halogenated silanes such as trichlorosilane, methyldichlorosilane, dimethylchlorosilane and trimethylsiloxydichlorosilane; alkoxysilanes such as trimethoxysilane, triethoxysilane, methyldimethoxysilane, phenyldimethoxysilane, 1,3,3,5,5,7,7-heptamethyl-1,1-dimethoxytetrasiloxane, and also acyloxysilanes.

The reaction temperature in the silylation is preferably in the range from 0 to 140° C., particularly preferably from 40 to 120° C. The reaction is usually carried out under atmospheric pressure, but can also be carried out under superatmospheric pressures, e.g. in the range from about 1.5 to 20 bar, or reduced pressures, e.g. from 200 to 600 mbar.

The reaction can be carried out without solvent or in the presence of a suitable solvent. Preferred solvents are, for example, toluene, tetrahydrofuran and chloroform.

A further important 1,2-addition is aminolysis (hydroamination). Here, a prochiral compound comprising at least one ethylenically unsaturated double bond is reacted with ammonia, a primary amine or a secondary amine in the presence of a chiral catalyst as described above to give chiral primary, secondary or tertiary amines. Suitable hydroamination processes are described in J. March, Advanced Organic Chemistry, 4th edition, pp. 768-770, which is hereby incorporated by reference.

A further important 1,2-addition is alcoholysis (hydro-alkoxy-addition). Here, a prochiral compound comprising at least one ethylenically unsaturated double bond is reacted with alcohols in the presence of a chiral catalyst as described above to give chiral ethers. Suitable alcoholysis processes are described in J. March, Advanced Organic Chemistry, 4th edition, pp. 763-764, which is hereby incorporated by reference.

A further important reaction is isomerization. Here, a prochiral compound comprising at least one ethylenically unsaturated double bond is converted in the presence of a chiral catalyst as described above into chiral compounds.

A further important reaction is cyclopropanation. Here, a prochiral compound comprising at least one ethylenically unsaturated double bond is reacted with a diazo compound in the presence of a chiral catalyst as described above to give chiral cyclopropanes.

A further important reaction is metathesis. Here, a prochiral compound comprising at least one ethylenically unsaturated double bond is reacted with a further olefin in the presence of a chiral catalyst as described above to give chiral hydrocarbons.

A further important reaction is aldol condensation. Here, a prochiral ketone or aldehyde is reacted with a silylenol ether in the presence of a chiral catalyst as described above to give chiral aldols.

A further important reaction is allylic alkylation. Here, a prochiral ketone or aldehyde is reacted with an allylic alkylating agent in the presence of a chiral catalyst as described above to give chiral hydrocarbons.

A further important reaction is [4+2]-cycloaddition. Here, reaction of a diene with a dienophile, of which at least one compound is prochiral, in the presence of a chiral catalyst as described above gives chiral cyclohexene compounds.

The invention further provides for the use of catalysts comprising at least one complex of a metal of transition group VIII with at least one ligand as described above for hydroformylation, hydrocyanation, carbonylation, hydroacylation, hydroamidation, hydroesterification, hydrosilylation, hydroboration, hydrogenation, aminolysis, alcoholysis, isomerization, metathesis, cyclopropanation or [4+2]-cycloaddition.

The process of the invention is suitable for preparing many useful optically active compounds. Here, a chiral center is generated stereoselectively. Examples of optically active compounds which can be prepared by the process of the invention are substituted and unsubstituted alcohols or phenols, amines, amides, esters, carboxylic acids or anhydrides, ketones, olefins, aldehydes, nitriles and hydrocarbons. Optically active aldehydes which are preferably prepared by the asymmetric hydroformylation process of the invention comprise, for example, S-2-(p-isobutylphenyl)propion-aldehyde, S-2-(6-methoxynaphthyl)propionaldehyde, S-2-(3-benzoylphenyl)propion-aldehyde, S-2-(p-thienoylphenyl)propionaldehyde, S-2-(3-fluoro-4-phenyl)phenyl-propionaldehyde, S-2-[4-(1,3-dihydro-1-oxo-2H-isoindol-2-yl)phenyl]propionaldehyde, S-2-(2-methylacetaldehyde)-5-benzoylthiophene, etc. Further optically active compounds which can be prepared by the process of the invention (including any formation of a derivative) are described in Kirk-Othmer, Encyclopedia of Chemical Technology, Third Edition, 1984, and The Merck Index, An Encyclopedia of Chemicals, Drugs and Biologicals, Eleventh Edition, 1989, which are hereby incorporated by reference.

The process of the invention makes it possible to prepare optically active products with high enantioselectivity and, if necessary, regioselectivity, e.g. in a hydroformylation. Enantiomeric excesses (ee) of at least 50%, preferably at least 60% and in particular at least 70%, can be achieved.

The products obtained are isolated by conventional methods known to those skilled in the art. These include, for example, solvent extraction, crystallization, distillation, evaporation, e.g. in a wiped film evaporator or falling film evaporator, etc.

The optically active compounds obtained by the process of the invention can be subjected to one or more subsequent reaction(s). Such processes are known to those skilled in the art. They include, for example, esterification of alcohols, oxidation of alcohols to aldehydes, N-alkylation of amides, addition of aldehydes onto amides, nitrile reduction, acylation of ketones by means of esters, acylation of amines, etc. For example, optically active aldehydes obtained by asymmetric hydroformylation according to the invention can be subjected to an oxidation to give carboxylic acids, reduction to give alcohols, aldol condensation to give α,β-unsaturated compounds, reductive amination to give amines, amination to give imines, etc.

A preferred conversion into a derivative comprises oxidation of an aldehyde prepared by the asymmetric hydroformylation process of the invention to form the corresponding optically active carboxylic acid. Many pharmaceutically important compounds such as S-ibuprofen, S-naproxen, S-ketoprofen, S-suprofen, S-fluorobiprofen, S-indoprofen, S-tiaprofenic acid, etc., can be prepared in this way.

Some preferred formations of derivatives are listed in the following table, giving olefin starting material, aldehyde intermediate and end product:

| Olefin | Aldehyde | Product |
|---|---|---|
| p-Isobutylstyrene | S-2-(p-Isobutylphenyl)propionaldehyde | S-Ibuprofen |
| 2-Vinyl-6-methoxynaphthalene | S-2-(6-Methoxynaphthyl)propionaldehyde | S-Naproxen |
| 3-Ethenylphenyl phenyl ketone | S-2-(3-Benzoylphenyl)propionaldehyde | S-Ketoprofen |
| 4-Ethenylphenyl 2-thienyl ketone | S-2-(p-Thienoylphenyl)propionaldehyde | S-Suprofen |
| 4-Ethenyl-2-fluorobiphenyl | S-2-(3-Fluoro-4-phenyl)phenylpropionaldehyde | S-Fluorobiprofen |
| 1,3-Dihydro-1-oxo-2H-isoindol-2-ylstyrene | S-2-(4-(1,3-Dihydro-1-oxo-2H-isoindol-2-yl)phenyl)- | S-Indoprofen |
| | propionaldehyde | |
| 2-Ethenyl-5-benzoylthiophene | S-2-(2-Methylacetaldehyde)-5-benzoylthiophene | S-Tiaprofenic acid |
| 3-Ethenylphenyl phenyl ether | S-2-(3-Phenoxy)propionaldehyde | S-Fenoprofen |
| Propenylbenzene | S-2-Phenylbutyraldehyde | S-Phenetamide, S-Butetamate |
| Isobutyl-4-propenylbenzene | S-2-(4-Isobutylphenyl)butyraldehyde | S-Butibufen |
| Phenyl vinyl ether | S-2-Phenoxypropionaldehyde | Pheneticillin |
| Vinyl chloride | S-2-Chloropropionaldehyde | S-2-Chloropropionic acid |
| 2-Vinyl-6-methoxynaphthalene | S-2-(6-Methoxynaphthyl)propionaldehyde | S-Naproxol |
| 2-Vinyl-6-methoxynaphthalene | S-2-(6-Methoxynaphthyl)propionaldehyde | S-Naproxen (Na salt) |
| 5-(4-Hydroxy)benzoyl-3H-pyrrolizine | 5-(4-Hydroxy)benzoyl-1-formyl-2,3-dihydropyrrolizine | Ketorolac or derivatives |
| tert-Butyl 2,3-dihydro[1,4]oxazine-4-carboxylate | tert-Butyl 3-formylmorpholine-4-carboxylate | tert-Butyl 3-hydroxymethylmorpholine-4- |
| | | carboxylate |
| 2,3-Dihydro[1,4]oxazine-4-carbaldehyde | Morpholine-3,4-dicarbaldehyde | 3-Hydroxymethylmorpholine-4-carbaldehyde |
| 1-Phenylvinyl acetate | 1-Phenylvinyl acetate | 3-Methylamino-1-phenylpropyl acetate |

### EXAMPLES

### Synthesis of the Ligands

### Example 1

### BINASKAT

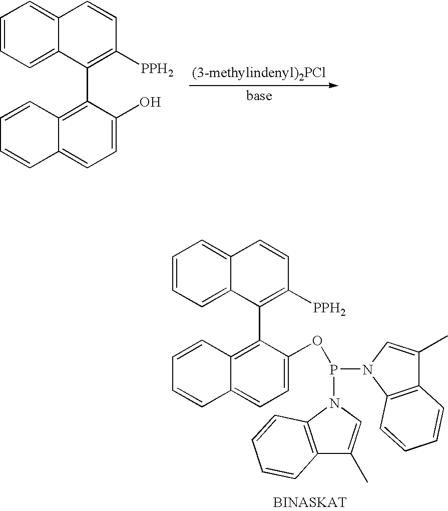

150 ml of THF are placed in a flask flushed with protective gas. 14.5 g (110 mmol) of PCl₃ are added while stirring. A mixture of 27.7 g of 3-methylindole (220 mmol) and 25.6 g of NEt₃ (250 mmol) in 30 ml of THF is slowly added dropwise at 15-20° C. The dropping funnel is subsequently rinsed twice with 20 ml of THF. The reaction solution is stirred under reflux. After a reaction time of 4 hours, GC monitoring indicates 70% of the target product. The THF is removed and the residue which remains is taken up in 160 ml of toluene.

15 ml of this solution are taken up in 50 ml of toluene. 1.7 g of NEt₃ (16.5 mmol) are added to this solution. While stirring, a solution of 3.0 g (6.6 mmol) of R-diphenylphosphino-2′-hydroxy-1,1′-binaphthyl in 20 ml of toluene is slowly added dropwise at room temperature. The reaction solution is stirred overnight at room temperature. The solvent is subsequently removed under reduced pressure and the residue which remains is purified by column chromatography. This gives 3.63 g (74% of theory) of a colorless crystalline powder.

³¹P-NMR (145 MHz): δ=103.1, −12.3 ppm

Asymmetric hydroformylations

### Example 2

### Hydroformylation of Styrene Using Rh/BINASKAT

18.8 mg of Rh(CO)₂acac and 216 mg of BINASKAT are dissolved in 15.8 g of toluene in an autoclave and the mixture is stirred at 50° C. under a reaction pressure of 9 bar set by means of synthesis gas for 16 hours. After addition of 1.75 g of styrene, the mixture is stirred at 60° C. under 9 bar of synthesis gas for 3 hours. The conversion is 98%. The ee determined by gas chromatography is 60%.

### Example 3

### Hydroformylation of Vinyl Acetate Using Rh/BINASKAT

18.9 mg of Rh(CO)₂acac and 200 mg of BINASKAT are dissolved in 15.7 g of toluene in an autoclave and the mixture is stirred at 50° C. under a reaction pressure of 9 bar set by means of synthesis gas for 4 hours. After addition of 1.75 g of styrene, the mixture is stirred at 50° C. under 9 bar of synthesis gas for 24 hours. The conversion is 93%. The ee determined by gas chromatography is 66%.

### Example 4

### Preparation of Ligand 2

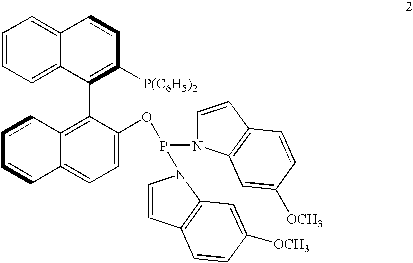

1.28 g of 6-methoxyindole (8.70 mmol) and 0.62 g of phosphorus trichloride (4.51 mmol) together with 10 ml of THF were placed in a 250 ml four-neck flask. A solution of 2.02 g (20.0 mmol) of triethylamine in 5 ml of THF was added dropwise to the above solution at −78° C. over a period of one hour. The cooling bath was subsequently removed and the reaction mixture was stirred overnight before a solution of 2.03 g (4.47 mmol) of (R)-(+)-2-diphenylphosphino-2′-hydroxy-1,1′-binaphthyl in 10 ml of THF was added dropwise at room temperature. The mixture was stirred overnight and the solids were subsequently filtered off from the reaction mixture. The solution obtained was evaporated and the residue was recrystallized from ethanol.

This gave 2.78 g (3.58 mmol; 80%) of the ligand as a pale yellow solid.

The following compounds were prepared analogously:

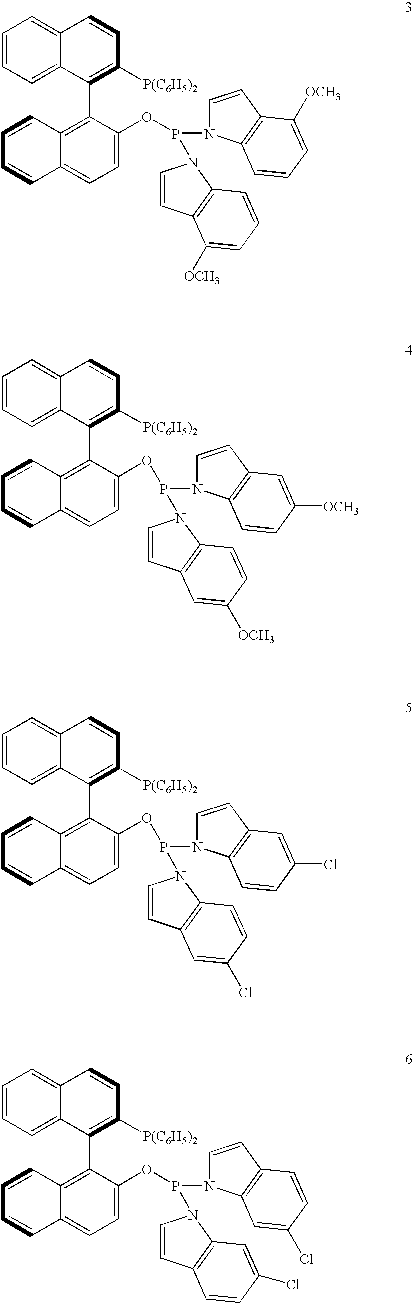

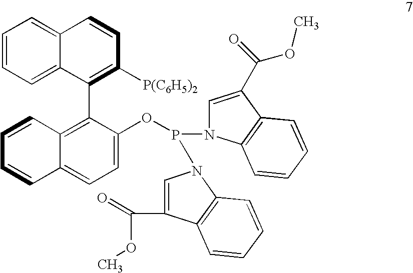

### Example 5

### Asymmetric Hydroformylation of Styrene Using Ligand 2

17.1 mg of Rh(CO)₂acac (66 μmol) and 207 mg of ligand 2 (267 μmol) together with 18.7 g of toluene were placed in a 100 ml autoclave which had been flushed three times with 5 bar of synthesis gas (CO/H₂=1:1). The autoclave was pressurized with 9 bar of synthesis gas (CO/H₂=1:1) at a temperature of 50° C. for 90 minutes before 2.0 g of styrene (19 mmol) were introduced by means of a lock. After setting the pressure to 20 bar of synthesis gas (CO/H₂=1:1), hydroformylation was carried out at 50° C. for 15 hours. This resulted in a 99% conversion of the starting material into 2-phenylpropanal and 3-phenylpropanal. A total of 77% of this was 2-phenylpropanal (iso selectivity: 78%), and the ee achieved was 62%.

### Conversion Analysis (GC, Direct Injection):

Column: Macherei Nagel OV-1, 25 m×0.32 mm×0.5 μm; detector: FID; temperature programme: 50° C. 2 min, 5° C./min to 90° C., 90° C. 5 min, 20° C./min to 300° C.; retention times: R_{T} styrene=10.8 min, R_{T} 2-phenylpropanal=18.4 min, R_{T} 3-phenylpropanal=19.5 min.

### Ee Analysis (GC, Direct Injection):

Column: BGB-174S, 30 m×0.25 mm×0.25 μm; detector: FID; temperature programme: 70° C. 10 min, 20° C./min to 120° C., 120° C. 7 min, 20° C./min to 180° C. 5 min; retention times: (R) enantiomer: 12.1 min, (S) enantiomer: 12.7 min.

### Examples 6 to 10

The results for the asymmetric hydroformulation of styrene using the ligands 3 to 7 were obtained in an analogous way and are shown in tabular form:

| | Conversion | Conversion | | ee |
|---|---|---|---|---|
| | into 2- and | into 2-phenyl- | | [%] |
| | 3-phenyl- | propanal | iso selectivity | (configuration |
| Ligand | propanal [%] | [%] | [%] | of product) |
| 3-methylcarboxyl (7) | 62 | 58 | 94 | 67 (R) |
| 4-methoxy (3) | 98 | 73 | 75 | 58 (R) |
| 5-methoxy (4) | 60 | 92 | 76 | 60 (R) |
| 5-chloro (5) | >99 | 73 | 73 | 61 (R) |
| 6-chloro (6) | >99 | 75 | 75 | 65 (R) |

1. A chelating phosphorus compound of formula I 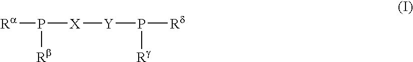
where
R^{α} and R^{β} are each, independently of one another, 5- to 7-membered heterocyclic groups which are bound via a ring nitrogen to the phosphorus atom or R^{α} and R^{β} together with the phosphorus atom to which they are bound form a 5- to 7-membered heterocycle which further comprises an optionally substituted nitrogen atom and a further heteroatom selected from among oxygen and optionally substituted nitrogen which are both bound directly to the phosphorus atom,
R^{γ} and R^{δ} are each, independently of one another, alkyl, cycloalkyl, heterocycloalkyl, aryl or hetaryl, where the alkyl radicals may have 1, 2, 3, 4 or 5 substituents selected from the group consisting of cycloalkyl, heterocycloalkyl, aryl, hetaryl, alkoxy, cycloalkoxy, heterocycloalkoxy, aryloxy, hetaryloxy, hydroxy, thiol, polyalkylene oxide, polyalkyleneimine, COOH, carboxylate, SO₃H, sulfonate, NE¹E², NE¹E²E³X⁻, halogen, nitro, acyl and cyano, where E¹, E² and E³ are identical or different radicals selected from the group consisting of hydrogen, alkyl, cycloalkyl and aryl and X⁻ is an anion equivalent,
and the cycloalkyl, heterocycloalkyl, aryl and hetaryl radicals R^{γ} and R^{δ} may have 1, 2, 3, 4 or 5 substituents selected from the group consisting of alkyl and the substituents mentioned above for the alkyl radicals R^{γ} and R^{δ}, and
X is O, S, SiR^{ε}R^{ξ} or NR^{η}, where R^{ε}, R^{ξ} and R^{η} are each, independently of one another, hydrogen, alkyl, cycloalkyl, heterocycloalkyl, aryl or hetaryl, and
Y is a chiral divalent bridging group.

2. The compound according to claim 1, wherein R^{α} and R^{β} are selected independently of one another from among groups of the formulas II.a to II.k 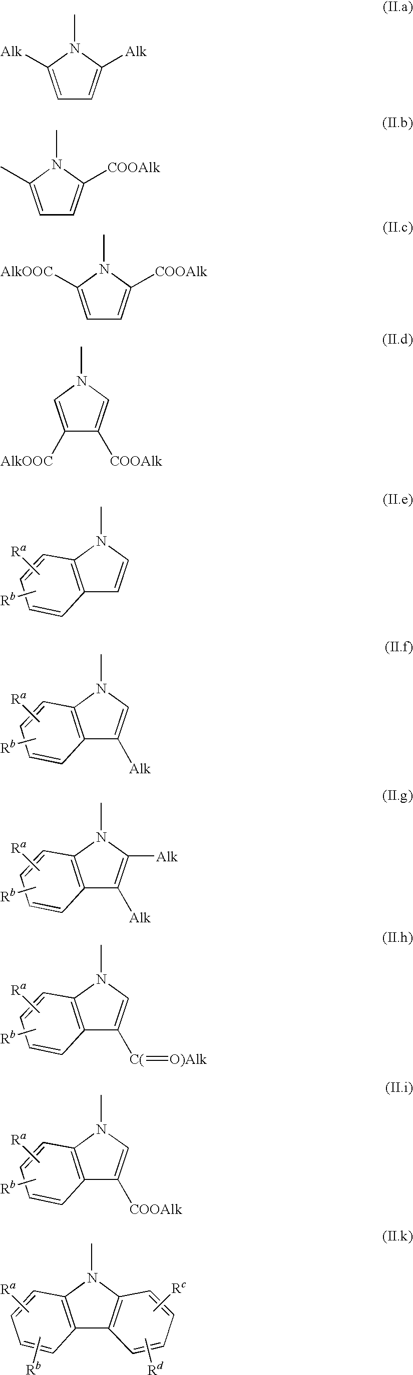
where
Alk is a C₁-C₄-alkyl group and
R^{a}, R^{b}, R^{c} and R^{d} are each, independently of one another, hydrogen, C₁-C₄-alkyl, C₁-C₄-alkoxy, acyl, halogen, trifluoromethyl, C₁-C₄-alkoxycarbonyl or carboxyl.

3. The compound according to claim 1, wherein R^{α} and R^{β} together form a 5- to 7-membered heterocycle which is optionally also fused with one, two, three or four cycloalkyl, heterocycloalkyl, aryl or hetaryl groups where the heterocycle and, if present, the fused-on groups may each bear, independently of one another, one, two, three or four substituents selected from the group consisting of alkyl, cycloalkyl, heterocycloalkyl, aryl, hetaryl, hydroxy, thiol, polyalkylene oxide, polyalkylenimine, alkoxy, halogen, COOH, carboxylate, SO₃H, sulfonate, NE⁴E⁵, NE⁴ E⁵E⁶X⁻, nitro, alkoxycarbonyl, acyl and cyano, where E⁴, E⁵ and E⁶ are identical or different radicals selected from the group consisting of hydrogen, alkyl, cycloalkyl and aryl and X⁻ is an anion equivalent.

4. The compound according to claim 3, wherein R^{α} and R^{β} together with the phosphorus atom to which they are bound form a chiral heterocycle.

5. The compound according to claim 3, wherein R^{α} and R^{β} together with the phosphorus atom to which they are bound form a group having one of the formulas II.1 to II.3 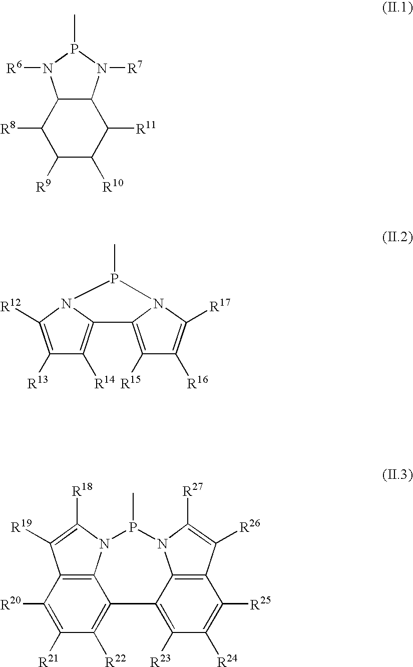
where
R⁶ and R⁷ are each, independently of one another, hydrogen, alkyl, cycloalkyl, aryl, hetaryl, mesylate, tosylate or trifluoromethanesulfonate,
R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶ and R²⁷ are each, independently of one another, hydrogen, alkyl, cycloalkyl, heterocycloalkyl, aryl, hetaryl, W′COOR^{f}, W′COO⁻M⁺, W′(SO₃)R^{f}, W′(SO₃)⁻M⁺, W′PO₃(R^{f})(R^{g}), W′(PO₃)²⁻(M⁺)₂, W′NE¹³E¹⁴, W′(NE¹³E¹⁴E¹⁵)⁺X⁻, W′OR^{f}, W′SR^{f}, (CHR^{g}CH₂O)ₓR^{f}, (CH₂NE¹³)ₓR^{f}, (CH₂CH₂NE¹³)ₓR^{f}, halogen, trifluoromethyl, nitro, acyl or cyano,
where
W′ is a single bond, a heteroatom, a heteroatom-comprising group or a divalent bridging group having from 1 to 20 bridge atoms,
R^{f}, E¹³, E¹⁴, E¹⁵ are identical or different radicals selected from
+
the group consisting of hydrogen, alkyl, cycloalkyl and aryl,
R^{g} is hydrogen, methyl or ethyl,
M⁺ is a cation equivalent,
X⁻ is an anion equivalent and
x is an integer from 1 to 240,
where two adjacent radicals R⁸ to R²⁷ together with the carbon atoms of the ring to which they are bound may also form a fused ring system having 1, 2 or 3 further rings.

6. The compound according to claim 1, wherein the bridging group Y in the formula I is selected from groups of the formulas III.a and III.b 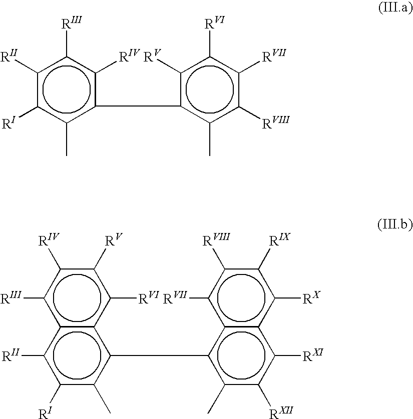
where
R^{I}, R^{I′}, R^{II}, R^{II′}, R^{III}, R^{III′}, R^{IV}, R^{IV′}, R^{V}, R^{VI}, R^{VII}, R^{VIII}, R^{IX}, R^{X}, R^{XI} and R^{XII} are each, independently of one another, hydrogen, alkyl, cycloalkyl, heterocycloalkyl, aryl, hetaryl, hydroxy, thiol, polyalkylene oxide, polyalkylenimine, alkoxy, halogen, SO₃H, sulfonate, NE¹⁰E¹¹, alkylene-NE¹⁰E¹¹, trifluoromethyl, nitro, alkoxycarbonyl, carboxyl, acyl or cyano, where E¹⁰ and E¹¹ are identical or different radicals selected from the group consisting of hydrogen, alkyl, cycloalkyl and aryl.

7. A catalyst comprising at least one complex of a transition metal which comprises at least one compound of the formula I as defined in claim 1 as ligand.

8. The catalyst according to claim 7, wherein the metal is selected from the group consisting of ruthenium, rhodium, iridium, palladium and platinum.

9. A process for preparing chiral compounds by reacting a prochiral compound comprising at least one ethylenically unsaturated double bond with a substrate in the presence of a chiral catalyst as defined in claim 7.

10. The process according to claim 9, wherein the prochiral compound is selected from the group consisting of olefins, aldehydes, ketones and imines.

11. The process according to claim 9 wherein the reaction is a hydrogenation, hydroformylation, hydrocyanation, carbonylation, hydroacylation, hydroamidation, hydroesterification, hydrosilylation, hydroboration, aminolysis, alcoholysis, isomerization, metathesis, cyclopropanation, aldol condensation, allylic alkylation or [4+2]-cycloaddition reaction.

12. The process according to claim 9 wherein the reaction is a 1,2-addition reaction.

13. The process according to claim 9 wherein the reaction is a hydroformylation reaction.

14. The process according to claim 9 wherein the reaction is a hydrogenation reaction.

15. A method for conducting hydrogenation, hydroformylation, hydrocyanation, carbonylation, hydroacylation, hydroamidation, hydroesterification, hydrosilylation, hydroboration, aminolysis, alcoholysis, isomerization, metathesis, cyclopropanation, aldol condensation, allylic alkylation or [4+2]-cycloaddition reactions comprising utilizing the catalyst according to claim 7 in the reaction.

16. The process according to claim 9 wherein the reaction is a 1-hydro-2-carbo-addition reaction.

17. A catalyst comprising at least one complex of a transition metal which comprises at least one compound of the formula I as defined in claim 2 as ligand.

18. A catalyst comprising at least one complex of a transition metal which comprises at least one compound of the formula I as defined in claim 3 as ligand.

19. A catalyst comprising at least one complex of a transition metal which comprises at least one compound of the formula I as defined in claim 5 as ligand.

20. A catalyst comprising at least one complex of a transition metal which comprises at least one compound of the formula I as defined in claim 6 as ligand.
